(19) United States
(12) Patent Application Publication
(10) Pub. No.: US 2008/0072768 A1
(43) Pub. Date: Mar. 27, 2008

(54) Food steamer

(76) Inventors: Gregory J. Foster, Chicago, IL (US); Robert W. Shelton, Winnetka, IL (US)

Correspondence Address: Paul E. Schaafsma;NovusIP, LLC, Suite 221, 521 West Superior Street, Chicago, IL, 60610-3135, US

(21) Appl. No.: 11/524,826

(22) Filed: Sep. 21, 2006

(51) Int. Cl. A47J 43/18

(52) U.S. Cl. 99/426

(57) ABSTRACT

In accordance with the principles of the present invention, a food steamer is provided. The food steamer includes an upper generally bowl-shaped portion defining a plurality of apertures and a lower portion comprising a stand. The upper generally bowl-shaped portion includes a lip that defines a plurality of scallops. A handle portion extends upwardly from at or near the center of the generally bowl-shaped upper portion. The upper generally bowl-shaped portion, the handle portion, and the lower portion formed of one piece molded silicon.

### FIELD OF THE INVENTION

The present invention relates to cooking utensils.

### BACKGROUND OF THE INVENTION

Many kinds of cooking pots are used to boil food. For example, deep pots are commonly used to cook pasta, vegetables, and long noodles such as spaghetti. Usually, when food is boiled, a strainer or colander is required to drain liquid/water. In the absence of a strainer or colander, resort is sometimes made to using a lid to hold food inside the pot while draining liquid, but that food can easily be dropped from the pot, and steam burns are a common occurrence.

In addition, food steamers have been known for a long period of time in the prior art. For example, vegetable steamer inserts are known that fit inside a larger pot and have perforations to allow steam to enter from the pot. Generally, vegetable steamer inserts are made of non-contaminating metal which has been perforated. A lid is used to cover the pot and insert to trap the steam inside.

Also, for instance, pasta cooking inserts have become popular. Pasta cooking inserts with perforations are two pots with one into another used to cook food, as well as drain it. The food is placed into the insert which is then placed into the pot, and, after the water is boiled and the food cooked, the insert is removed, allowing water to drain through the perforations. While pasta cooking inserts are used to drain water, they tend to be expensive and bulky.

There is a great need, therefore, for a safe and effective cooking device that provides the functions and advantages of conventional steamers in a convenient, cost effective manner.

### SUMMARY OF THE INVENTION

A cooking utensil in accordance with the principals of the present invention provides a safe and effective cooking device that provides the functions and advantages of conventional steamers in a convenient, cost effective manner. In accordance with the principles of the present invention, a food steamer is provided. The food steamer includes an upper generally bowl-shaped portion defining a plurality of apertures and a lower portion comprising a stand. The upper generally bowl-shaped portion includes a lip that defines a plurality of scallops. A handle portion extends upwardly from at or near the center of the generally bowl-shaped upper portion. The upper generally bowl-shaped portion, the handle portion, and the lower portion formed of one piece molded silicon.

### BRIEF DESCRIPTION OF THE DRAWINGS

FIG. 1 is perspective view of a food steamer in accordance with the principles of the present invention.

FIG. 2 is an overhead view of a food steamer in accordance with the principles of the present invention.

FIG. 3 is elevated side-view of a food steamer in accordance with the principles of the present invention.

### DETAILED DESCRIPTION OF THE INVENTION

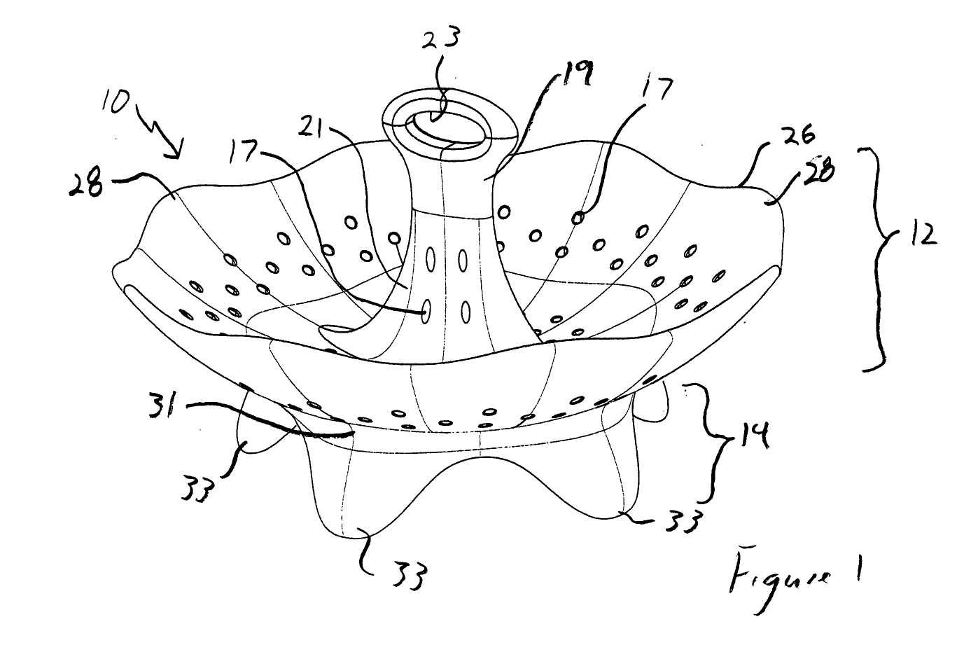

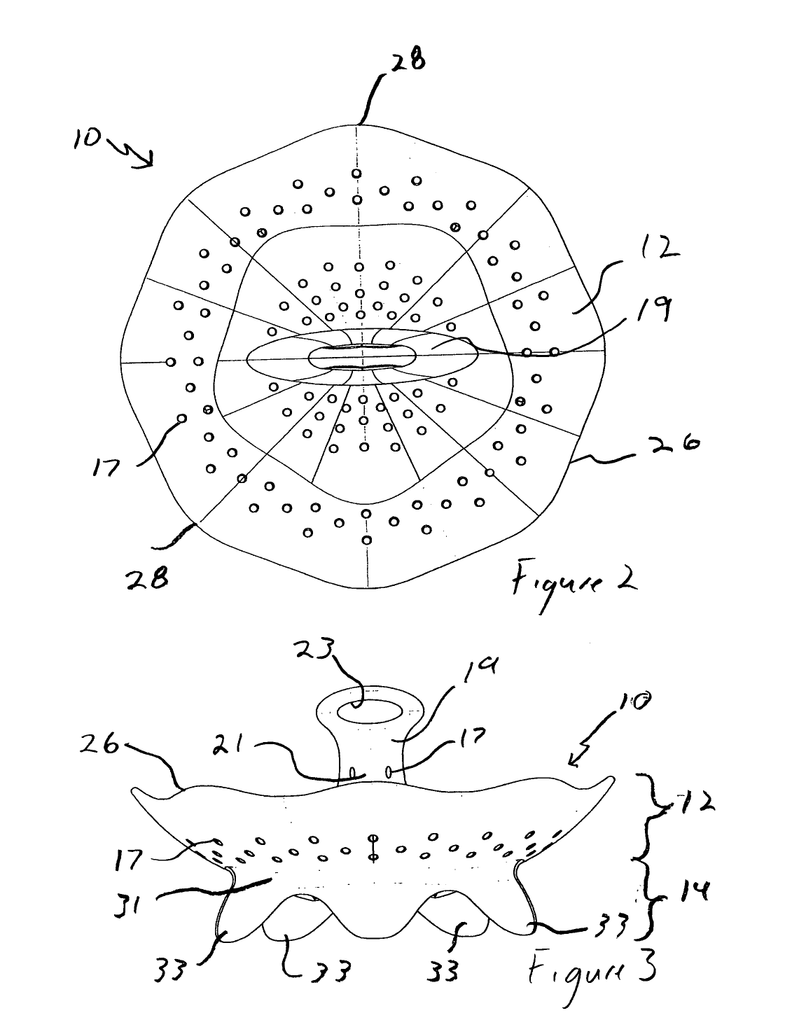

Referring to FIG. 1, a perspective view of a food steamer 10 in accordance with the principles of the present invention is seen. The food steamer 10 can include a generally bowl-shaped upper portion 12 and a lower portion 14. Referring to FIGS. 1 and 2, the generally bowl-shaped upper portion 12 defines a plurality of apertures 17 to allow steam to flow through the generally bowl-shaped upper portion 12.

A handle portion 19 is provided upwardly extending from at or near the center of the generally bowl-shaped upper portion 12. The handle portion 19 can include a shaft 21 the length of which is sufficient long to allow the user to easily grab. The handle portion 19 can further define an aperture 23 at the upper end of the shaft 21 sized to allow a user to grasp onto the handle portion 19 via the aperture 23. In one embodiment, the shaft is hollow and defines a plurality of apertures 17 to allow steam to flow through the handle portion 19. In one embodiment, the handle portion 19 is made sufficiently flexible so as to fold over when pressed upon with a lid but sufficiently resilient to pop up when taking the lid off the pot.

The generally bowl-shape of the upper portion 12 opens upwardly. The generally bowl-shaped upper portion 12 includes a lip 26. The lip 26 defines a plurality of scallops 28. The scalpels 28 enable the outermost edge the generally bowl-shaped upper portion 12 to engage the inside surface of a pot while retaining the inside edge of the generally bowl-shaped upper portion 12 a distance from the inside surface of the pot to enable steam to pass.

Referring to FIGS. 1 and 3, the lower portion 14 of the food steamer 10 comprises a stand 31. In one embodiment, the stand 31 can comprise a plurality of legs 33. The stand 31 raises the generally bowl-shaped upper portion 12 above a floor of a pot, thereby raising the food that is being steamed above the water contained in the pot that is heated to produce the stream.

The food steamer of the present invention is preferably formed of one piece molded silicon. The use of such materials further results in a non-stick design. In addition, by using flexible materials the food steamer of the present invention conforms to a variety of cookware sizes and will not harm or scratch metal or coated cookware. The silicon design results in a device that is easy to clean and stain resistant. Further, the food steamer of the present invention can be deformed to aid in storage.

The food steamer of the present invention can preferably be made of “high-temperature” silicon which can have heat resistance up to about 650 F/350 C degrees. The present invention can be offered in small, medium, and large sizes to accommodate different sizes of pots. The present invention could also be used for additional applications such as for example draining food that has been cooked in liquid or a cooking insert.

The food steamer 10 is flexible, but is made of sufficiently high durometer silicon to retain its general position with the weight of the food to be steamed present. In one embodiment, the food steamer 10 can be made of silicon having a durometer of around 60 shore to provide suitable rigidity. In additional embodiments, different portions of the food steamer 10 can be made of different thicknesses of material in order to increase or decrease the rigidity of such portions. For example, the scallops 28 on the lip 26 of the generally bowl-shaped upper portion 12 can be made thinner, thereby increasing their flexibility to accommodate different sized pots. In addition, the legs 33 of the stand 31 can be made thicker, thereby increasing the rigidity of the stand. The handle portion can likewise be sized in order to effectuate the appropriate level of rigidity

Thus, a food steamer in accordance with the principles of the present invention is easy to clean, dishwasher safe, difficult to stain, virtually unlimited color offerings with the silicon material, and silicon will not scratch cookware, high-end stoves, etc.

It should be understood that various changes and modifications to the preferred embodiments described herein would be apparent to those skilled in the art. Such changes and modifications can be made without departing from the spirit and scope of the present invention and without diminishing its attendant advantages. It is therefore intended that such changes and modifications be covered by the appended claims.

What is claimed is:

1. A cooking utensil comprising:
an upper generally bowl-shaped portion defining a plurality of apertures;
a lower portion comprising a stand; and
a handle portion upwardly extending from at or near the center of the generally bowl-shaped upper portion;
the upper generally bowl-shaped portion, the lower portion, and the handle portion formed of a material that is flexible, but sufficiently ridged to retain the cooking utensil general shape with food weight present.

2. The cooking utensil of claim 1 further wherein the handle portion comprises a shaft and further define an aperture at the upper end of the shaft sized to allow a user to grasp onto the handle portion via the aperture.

3. The cooking utensil of claim 2 further wherein the shaft is hollow and defines a plurality of apertures;

4. The cooking utensil of claim 1 further wherein the handle portion is made sufficiently flexible so as to fold over when pressed upon with a lid but sufficiently resilient to pop up when taking the lid off the pot.

5. The cooking utensil of claim 1 further wherein the generally bowl-shaped upper portion includes a lip that defines a plurality of scallops.

6. The cooking utensil of claim 1 further wherein the stand comprises a plurality of legs.

7. The cooking utensil of claim 1 further wherein the upper generally bowl-shaped portion, the lower portion, and the handle portion formed of one piece molded silicon.

8. The cooking utensil of claim 1 further wherein the lower portion is thicker relative to the upper generally bowl-shaped portion.

9. A cooking utensil comprising an upper generally bowl-shaped portion defining a plurality of apertures and a lower portion comprising a stand comprised of a plurality of legs, the upper generally bowl-shaped portion and the lower portion formed of one piece molded silicon.

10. The cooking utensil of claim 9 further comprising a handle portion upwardly extending from at or near the center of the generally bowl-shaped upper portion.

11. The cooking utensil of claim 9 further wherein the upper generally bowl-shaped portion and the lower portion formed of one piece molded “high-temperature” silicon.

12. The cooking utensil of claim 9 further wherein the generally bowl-shaped upper portion includes a lip that defines a plurality of scallops.

13. The cooking utensil of claim 9 further wherein the lower portion is thicker relative to the upper generally bowl-shaped portion.

14. A cooking utensil comprising:
a lower portion comprising a stand; and
an upper generally bowl-shaped portion defining a plurality of apertures, the generally bowl-shaped upper portion including a lip that defines a plurality of scallops;
the upper generally bowl-shaped portion and the lower portion formed of a material that is flexible, but sufficiently ridged to retain the cooking utensil general shape with food weight present.

15. The cooking utensil of claim 14 further comprising a handle portion upwardly extending from at or near the center of the generally bowl-shaped upper portion

16. The cooking utensil of claim 14 further wherein the scallops define an outer edge that is thinner relative to the inner edge.

17. The cooking utensil of claim 14 further wherein the stand comprises a plurality of legs.

18. The cooking utensil of claim 14 further wherein the upper generally bowl-shaped portion and the lower portion are formed of one piece molded silicon.

19. The cooking utensil of claim 14 further wherein the lower portion is thicker relative to the upper generally bowl-shaped portion.
